(19) United States
(12) Patent Application Publication
(10) Pub. No.: US 2012/0279746 A1
(43) Pub. Date: Nov. 8, 2012

(54) VAPOR BARRIER MOUNTING APPARATUS AND METHOD

(75) Inventors: Jean-Guy Gagne, Etobicoke (CA); James W. Rogers, Toronto (CA)

(73) Assignee: Brainwave Research Corporation, Markham (CA)

(21) Appl. No.: 13/185,144

(22) Filed: Jul. 18, 2011

Related U.S. Application Data
(60) Provisional application No. 61/483,254, filed on May 6, 2011.

(51) Int. Cl. H02G 3/14

(52) U.S. Cl. 174/50.51

(57) ABSTRACT

An opening in a vapor barrier membrane interior to a wall of a building structure can be sealed by an enclosure having a planar member that is bonded to the inner side of the membrane. The enclosure forms an integrally walled cavity suitable for enclosing one or more electrical devices. An aperture is sized to surround the membrane opening and seal the enclosure to the membrane. The enclosure is flexible to permit manual insertion through the membrane opening.

This disclosure contains subject matter in common with provisional application 61/483,254, filed May 6, 2011 by applicants Jean-Guy Gagne and James W. Rogers. The benefit of provisional application 61/483,254 is claimed under 35 U.S.C. 119(e).

### BACKGROUND

This disclosure is related to preservation of vapor barriers in building structures. More particularly, integrity of vapor barrier functionality is maintained when access to the interior of a wall or ceiling requires breaching a vapor barrier membrane.

Vapor barriers are required to prevent condensation that would otherwise occur from interaction between cold ambient air from outside the building and the warmer inside air. A vapor barrier seals against cold air flow within wall and ceiling spaces. In various situations, it would be desirable to gain access within an existing wall or ceiling that has been protected by a vapor barrier. For example, addition of accessories such as electrical boxes, data ports, light fixtures or the like would require forming an opening in the wall and breaching the vapor barrier. As another example, it may become necessary to access a gas or plumbing valve that is interior to a wall or ceiling. The need to provide vapor seal protection applies to building construction, i.e., prior to completion of walls and ceilings, as well as to protection when gaining access through a pre-existing wall or ceiling. Typically, attempts are made to prevent air leakage haphazardly by manually taping or patching spaces in barrier membranes. Such efforts become time intensive and ineffective as they are susceptible to breakage.

A need thus exists for a device that can effectively and efficiently preserve vapor barrier functionality in buildings in which existing vapor barrier membranes are breached when access is provided to the interior of walls or ceilings. Minimization of installation time is a significant cost saving consideration. Such a device would also be desirable in new building sites to provide vapor barrier protection for internal access prior to completion of wall construction. Such effective vapor barrier protection would provide advantageous energy conservation as prevention of the escape of air through the building wall reduces loading on heating and air conditioning operations.

### SUMMARY OF DISCLOSURE

The needs described above are fulfilled, at least in part, by use of a device for sealing an opening in a vapor barrier membrane. Such device may include an enclosure having a planar member that is to be bonded to the inner side of the membrane. The planar member is formed with an aperture sized to surround the membrane opening. Enclosure walls extend from the planar member to a back wall to form an integral cavity. The enclosure is flexible to permit manual insertion thereof through the membrane opening.

A fastener joined to a surface of the planar member permits bonding with the planar surface with an interior surface of the membrane, thereby forming a seal around the membrane within the cavity. The fastener may comprise an adhesive contained at the planar surface. A compressive force manually applied between the planar member and the wall provides adhesive bonding of the enclosure to the interior membrane surface. A removable release liner covering the adhesive may be provided to preserve the adhesive prior to application of the enclosure to the membrane. The release liner may later be easily removed manually. Alternatively, the adhesive may be contained in a sealed blister pack cavity at the planar surface of the enclosure member. In yet another alternative, the fastener may comprise double sided tape or the like that is fixed to the planar surface.

The enclosure cavity may be sized to house one or more electrical devices including, for example electrical boxes and telecommunication connectors. The enclosure may contain one or more access sites for coupling an electrical wire from outside the enclosure to the electrical device(s) within the cavity. The enclosure thickness at an access site may be less than the nominal thickness of the closure material to permit easy penetration of the enclosure material by an electrical wire. The enclosure access site material may be self-sealing to maintain the enclosure seal integrity.

An enclosure access site may comprise a conical formation extending outwardly of the cavity wall. The conical formation may be marked with a plurality of spaced indicia, corresponding respectively to different wire sizes. Alternatively, one or more access site formations may extend into the cavity. A plurality of inwardly extending access sites may be substantially cylindrically shaped with different dimensions that correspond to respective different wire sizes.

The enclosure may be formed with a collapsible side wall and a rear wall. The side wall can be compressed to reduce the volume of the cavity prior to insertion of the enclosure through the wall opening. For example, the side wall may be accordion or bellows-shaped. After insertion, the side wall can be expanded to the required cavity size. One or more electrical wire access sites can be formed in the wall of the enclosure.

A device to provide vapor barrier protection for accessing a wall interior may be formed of a flexible material having a planar surface sized to surround a membrane opening. The flexible material may include a sealable access site for providing access to the interior of the building wall. A fastener joined to the planar surface of the flexible material permits bonding with an interior surface of the membrane, thereby forming a seal around the membrane opening within the wall cavity. If simple manual access is required, the sealable access site may comprise a re-sealable plastic zipper. The access site may contain a threaded port for coupling an electrical wire, pipe or other device from the interior of the building wall to the exterior of the wall. An elastomeric gland may be compressed between the port and a mating threaded cap to maintain hermetic sealing across the flexible material upon insertion of a penetrating entity through the gland.

The devices described above are applicable for barrier protection in new building construction, in advance of attachment of the building wall. An airtight grommet assembly may be incorporated in a wall of the enclosure to provide access for electrical wires, or other penetrating entity, such as gas or water pipe. As an alternative to the use of adhesive, the flexible member may project from the planar surface to form a channel that engages a flange mounted to the building structure, such as a stud. A compression seal is established between the flexible member and the vapor barrier membrane when wall construction is completed by compression of the projecting flexible member between the wall and the flange.

### BRIEF DESCRIPTION OF DRAWINGS

Various exemplary embodiments are illustrated by way of example, and not by way of limitation, in the figures of the accompanying drawings in which like reference numerals refer to similar elements and in which:

FIG. 1a is a perspective view of a preferred embodiment of a vapor barrier assembly device suitable for installation in a pre-existing wall;

FIG. 1b is an exploded perspective view of the assembly of FIG. 1a;

FIG. 1c is a section view of the assembly of FIG. 1a adjacent a drywall;

FIG. 1d is an exploded perspective view of the assembly of FIG. 1a in use with an electrical device;

FIG. 1e is a section view of the assembly shown in FIG. 1d;

FIG. 2a is a perspective view of a second embodiment of a vapor barrier assembly with an integral blister pack containing a bonding adhesive;

FIG. 2b is a partial section view of the assembly of FIG. 2a;

FIG. 3 is a perspective view of a modification of the assembly of FIG. 1a;

FIG. 4a is a perspective view of a modification of the assembly of FIG. 1a;

FIG. 4b is a top perspective view of the assembly of FIG. 4a;

FIG. 4c is a section view of the assembly of FIG. 4b;

FIGS. 4d-4j are detail views of projection elements of the assembly of FIG. 4a and variations thereof;

FIG. 5a is a perspective view of a vapor barrier assembly device suitable for installation during rough-in stage of new construction;

FIG. 5b is a top perspective view of the assembly of FIG. 5a;

FIG. 5c is a section view of the assembly of FIG. 5b;

FIG. 6 is a perspective view of a vapor barrier assembly that permits manual access to a wall interior;

FIG. 7a is a perspective view of a vapor barrier assembly for sealing an electrical wire;

FIG. 7b is an exploded view of the vapor barrier assembly of FIG. 7a;

FIG. 8 is a front view of a vapor barrier assembly having a zipper lock device for permitting manual access to a wall interior;

FIG. 9 is a perspective view of a vapor barrier assembly having a tubular entity and retainer to permit access to a wall interior;

FIG. 10 is a perspective view of a variation of the vapor barrier assembly of FIG. 9;

FIG. 11 is a perspective view of an embodiment of a vapor barrier assembly for housing a recessed light fixture assembly;

FIG. 12 a perspective view of an alternative embodiment of a vapor barrier assembly for housing a recessed light fixture assembly; and

FIG. 13a is a perspective view of an alternative collapsible vapor barrier assembly shown in a collapsed state;

FIG. 13b is a perspective view of the vapor barrier assembly of FIG. 13a shown in an expanded state;

FIG. 13c is a front view of the collapsible assembly shown in FIGS. 13a and 13b;

FIG. 13d is a section view of the assembly shown in FIG. 13a;

FIG. 13e is a section view of the assembly shown in FIG. 13b;

FIG. 14a is an exploded view of an alternative vapor barrier assembly device suitable for installation during rough-in stage of new construction;

FIG. 14b is perspective view of the assembly of FIG. 14a installed on a bracket;

FIG. 14c is a partial section view of the assembly shown in FIG. 14b;

FIG. 14d is an exploded view of the vapor barrier assembly of FIG. 14a when fully installed with a building wall;

FIG. 15 is a perspective view of an alternative collapsible assembly device suitable for installation during rough-in stage of new construction;

FIG. 16 is a perspective view of another collapsible assembly device suitable for installation during rough-in stage of new construction;

FIG. 17a is a perspective view of another vapor barrier assembly suitable for installation during rough-in stage of new construction including a grommet assembly;

FIG. 17b is an exploded view of the grommet assembly of the device shown in FIG. 17a;

FIG. 17c is a front view of the vapor barrier assembly of FIG. 17a with grommet elements shown in exploded view;

FIG. 17d is a partial section view taken from FIG. 17c;

FIG. 18a is a perspective view of a vapor barrier patch to be used for new construction;

FIG. 18b is an exploded view of the vapor barrier assembly shown in FIG. 18a;

FIG. 19a is a perspective view of another vapor barrier assembly to be used for new construction;

FIG. 19b is a different perspective view of the vapor barrier assembly of FIG. 19a;

FIG. 19c is an exploded view of the vapor barrier assembly of FIGS. 19a and 19b for installation;

FIG. 20a is a perspective view of an alternative vapor barrier assembly to be used for new construction;

FIG. 20b is a partial section view of the assembly shown in FIG. 20a; and

FIG. 20c is an exploded view of the vapor barrier assembly of FIGS. 20a and 20b, suitable for installation.

### DETAILED DISCLOSURE

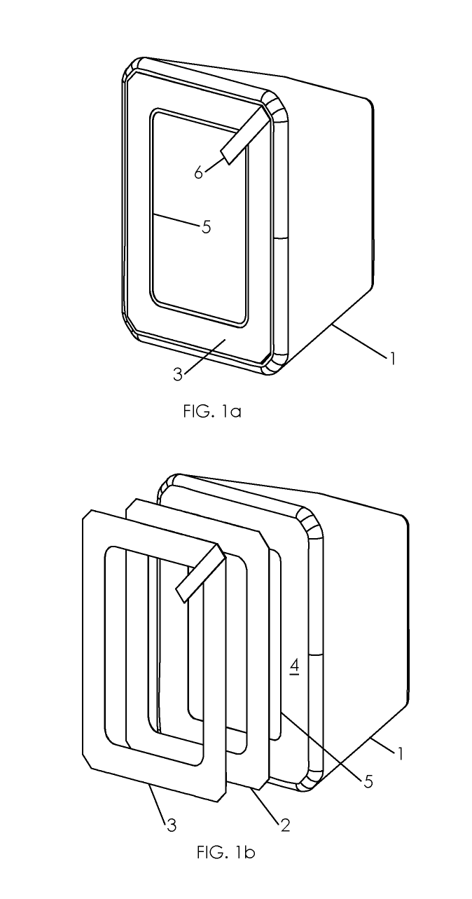

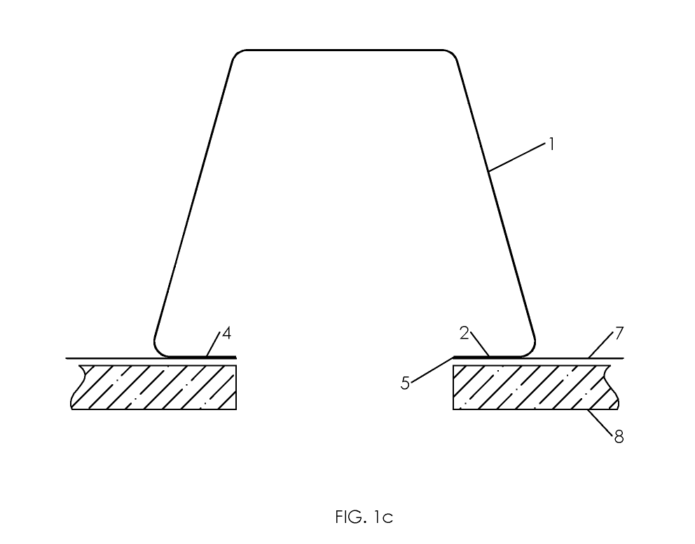

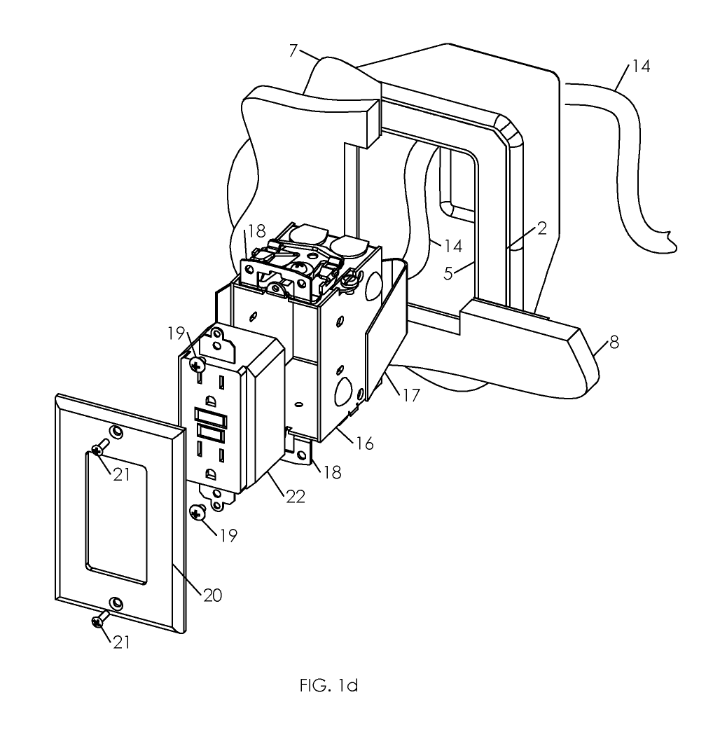

As shown in the perspective view of FIG. 1a and the exploded view of FIG. 1b, enclosure 1 can be used to seal a hole in an air/vapor barrier membrane situated behind drywall 8 in a building. Enclosure 1 can be made of a flexible material, such as 0.006 thick polyethylene or the like, by blow molding. Adhesive 2 and release paper 3 are applied to the planar surface 4 around the aperture 5. Pull tab 6 allows the release liner to be withdrawn after the enclosure is in place.

FIG. 1c shows the enclosure 1 in section view, positioned behind drywall 8. A planar member having a surface 4 of the enclosure is bonded with adhesive 2 to the inner side of the barrier membrane 7 that surrounds an opening in the membrane. The planar member provides an undercut to facilitate manual access to the inside of the planar member. In installation, a finger, hand or tool can be inserted into the enclosure 1 to apply pressure to the opposite side of planar surface 4 to compress the adhesive 2 and bond the enclosure surface to membrane 7. The cavity formed by enclosure 1 is thus sealed to the membrane 7 by an easily performed, time efficient procedure.

FIG. 1d is an exploded view of an installation of an electrical device assembly in the opening of drywall 8 in combination with barrier member 7 sealed by enclosure 1. FIG. 1e is a section view of the combination. A line voltage electrical cable 14 has been fished through the wall cavity behind the drywall 8 and vapor barrier 7 and fed through a rework hole in the vapor barrier 7. Prior to application of enclosure 1 to membrane 7, the electrical cable has been fed through the enclosure via a cable sealing feature 15, shown in FIG. 1e, which forms a seal around the wire to prevent air or vapor from passing through the enclosure penetration. Sealing feature 15 may be replicated at another enclosure access site if an additional wire connection is needed. Sealing feature 15 may comprise a reduced wall thickness in the enclosure wall that will encompass the cable as it pierces the wall. Alternatively, felt, foam, rubber or alternative material gaskets can be bonded to the enclosure wall to facilitate piercing while maintaining the air/vapor seal. A cut can be made in the gasket material to locate the wire piercing location and to seal around it as it passes through the enclosure wall while preventing the propagation of the tear in the wall caused by piercing. Alternatively, caulk can be dabbed around the piercing location if no other means is provided.

Enclosure 1, having passed through the opening in the drywall 8 and vapor barrier membrane 7, has been bonded via the adhesive 2 to the vapor barrier 7. The electrical cable 14 has been fed to electrical box 16. Electrical box 16 can then be installed in wall 8. The box 16 is inserted through the opening in the drywall 8 and vapor barrier 7 as well as the aperture 5 of the enclosure until ears 18 of box 16 (FIG. 1d) rest on the front face of wall 18. A screw in the back of the electrical box 16 can be tightened to move rework attachment plates 17 toward the drywall 8 and apply pressure between box 16 and wall 8. After wiring an electrical outlet 22 or other device, such as an electrical switch, it is secured to the electrical box 16 with screws 19. Wall plate 20 is fastened to the outlet 22 with two screws 21. Although a single electrical box has been illustrated, enclosure 1 can be dimensioned to accommodate two or more ganged electrical boxes.

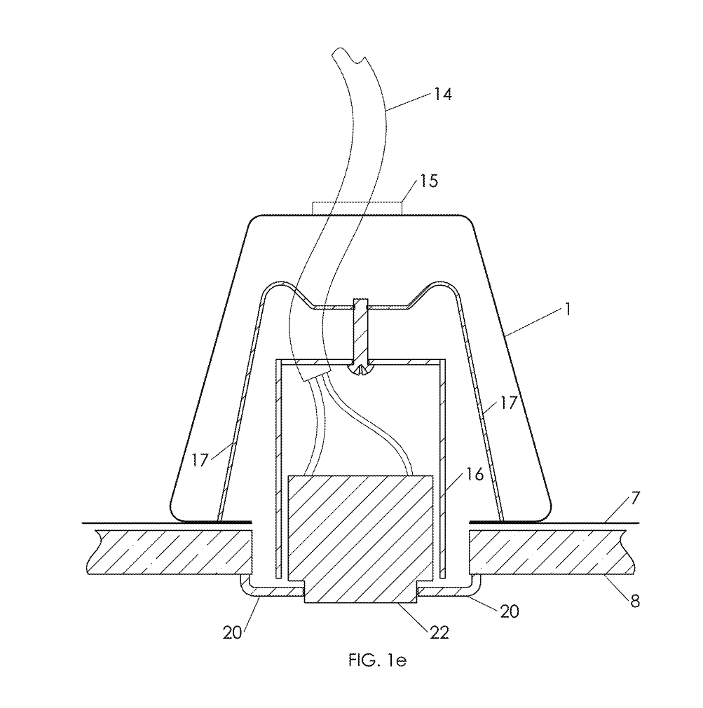

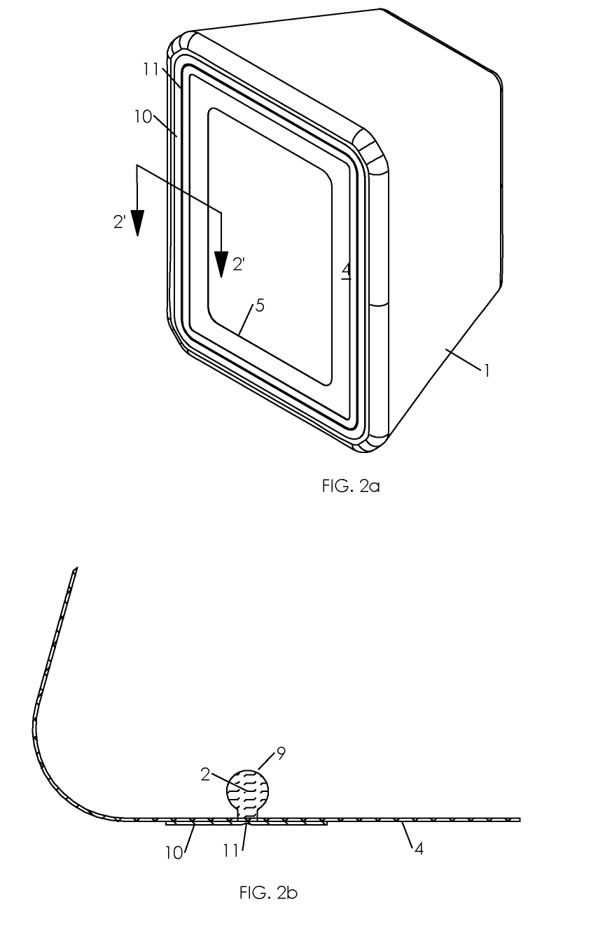

An alternative embodiment of a vapor barrier assembly device is illustrated in FIG. 2a and in partial section 2′-2′ in FIG. 2b. This embodiment differs from the device of FIG. 1a in the use of a different bonding means. A blister pack cavity 9 contains an adhesive 2 preserved hermetically with a lidding 10. Lidding 10 may be constructed of polyethylene or like material. Lidding 10 has an area of reduced thickness 11 adjacent the blister pack cavity 9. Lidding 10 can be ultrasonically welded to the planar surface 4 of the enclosure or bonded using an alternative adhesive. Similar to the installation described with respect to FIG. 1a, pressure can be applied to blister pack cavity 9 on the opposite side of planar surface 4 to break lidding 10. Adhesive 2 is then compressed between surface 4 of the enclosure and the membrane 7 to seal the two together. Other suitable materials, e.g., aluminum foil, may be used as a lidding material in this embodiment.

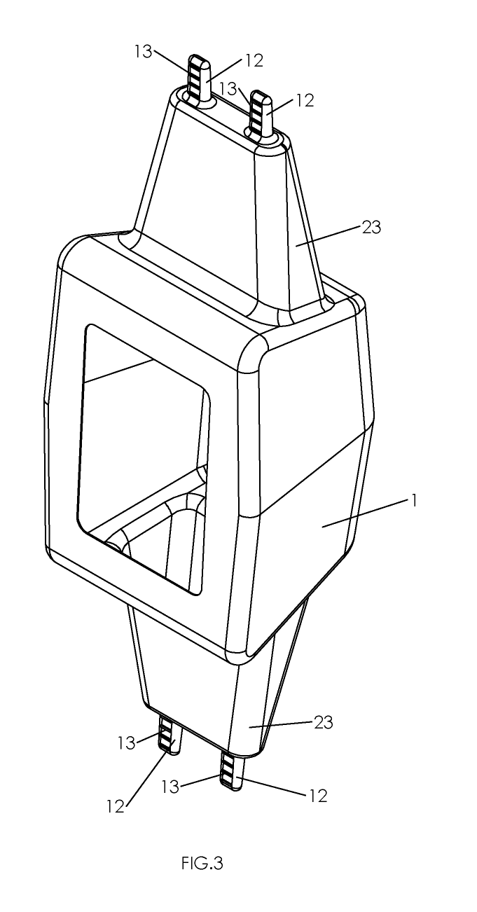

An alternative embodiment of a vapor barrier assembly device is illustrated in FIG. 3. This embodiment differs from that of FIG. 1a by expansion of upper and lower portions of enclosure 1 by pyramidal portions 23. Conically shaped forms 12 serve as access sites for introducing electrical wires into the enclosure cavity from the space behind drywall 8. Any number of such conically shaped forms may be utilized as required by the particular needs of the electrical device to be installed. Gradations 13 on the conical forms 12 indicate cut locations for penetrating and sealing around different size wire, pipe or other entity. After cutting conical form 12 at the appropriate gradation 13 and inserting the wire, a strip of tape can be wrapped around the conical shape and the wire to ensure a positive seal. Alternatively, the material of the conical form may be made sufficiently resilient to squeeze the wire and ensure a positive seal. The conical forms 12 can be pushed inside out after cutting to facilitate insertion of wires. If only a single wire is needed to penetrate the enclosure only one of the conical forms would be cut or punctured. The pyramidal portions 23 allow space for extra wire that may be needed for wiring the box when outside the wall and then contained within the enclosure after installation of the box.

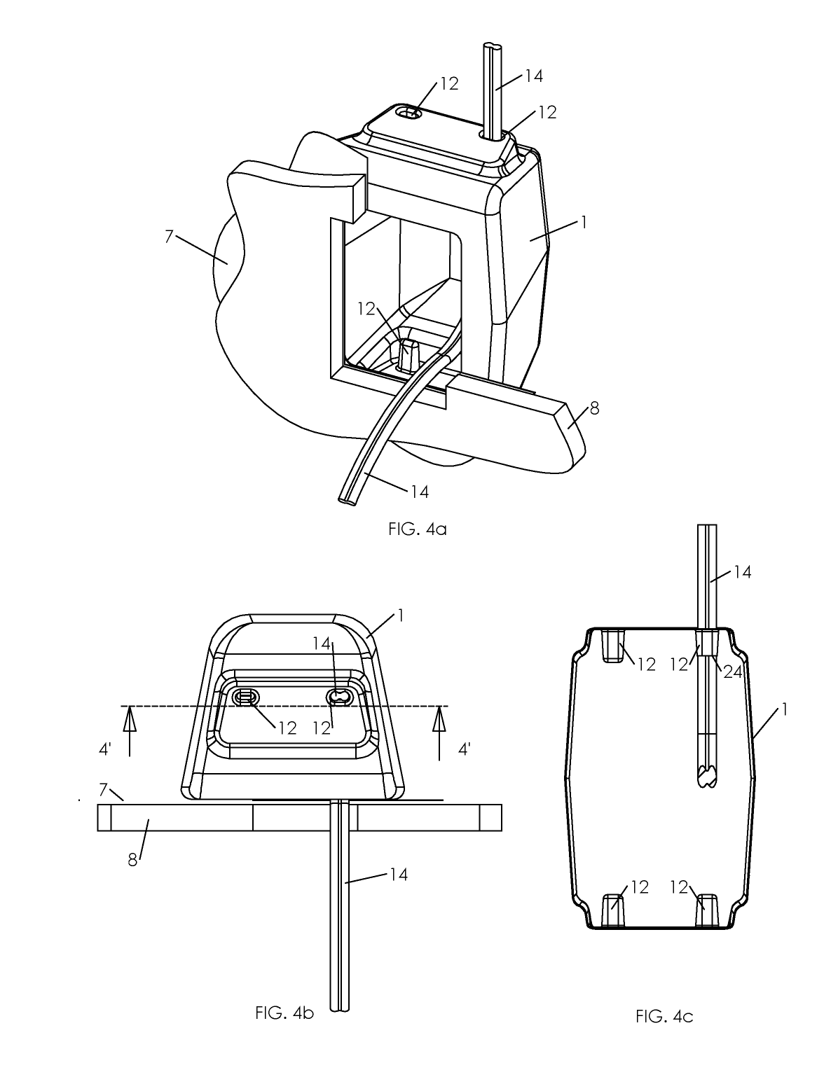

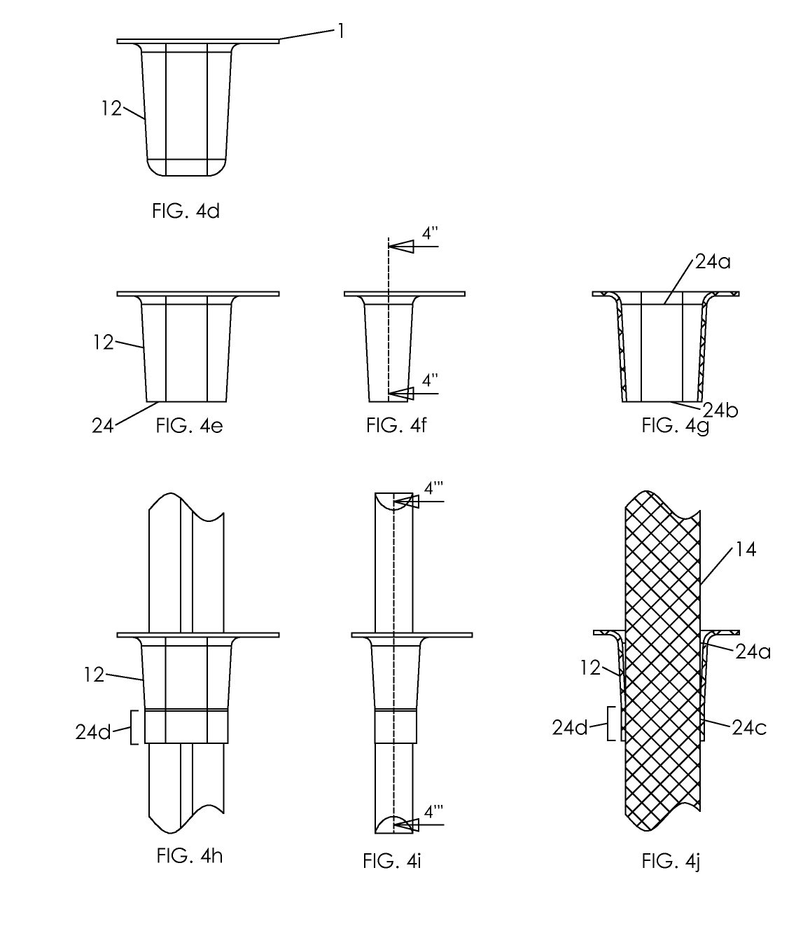

Another alternative embodiment, is illustrated in FIGS. 4a-4c. Conical forms 12 project into the enclosure 1 to serve as access sites facilitating insertion of the wire or other penetrating element. As shown in the section view of FIG. 4c, conical form 12 has been cut or punctured at 24. The resiliency of the material squeezes the wire 14 and ensures a positive seal. FIG. 4d shows the conical form 12 in detail, prior to cutting.

Any of a plurality of different size conical forms that correspond to the size of the wire to be introduced into the cavity may be utilized. FIGS. 4e and 4f illustrate two different conical forms 12 in detail cut along edge 24 prior to insertion of the wire 14. Section 4″-4″ of FIG. 4f is shown in FIG. 4g. The dimension of the conical form at the top 24a is larger than the wire to facilitate insertion of the wire into the form. The dimension 24b at the bottom of the conical form is smaller than the wire and stretches as the wire is inserted. FIGS. 4h-4j, which correspond to FIGS. 4e-4g, show wire 14 passing through and sealed in conical form 12. Section 4′″-4′″ of FIG. 4i is shown in FIG. 4j. The contact surface 24c in the stretched portion 24d around the wire creates a seal. The resiliency of the enclosure material permits the stretching. Alternatively, rather a conical form of different material from that of the enclosure material can be bonded to the enclosure.

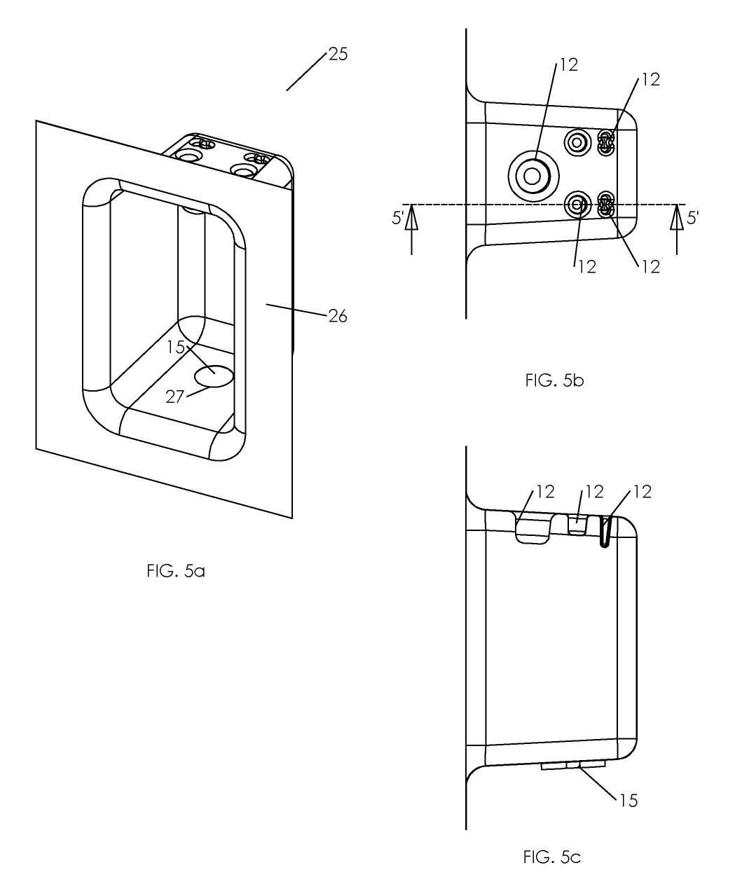

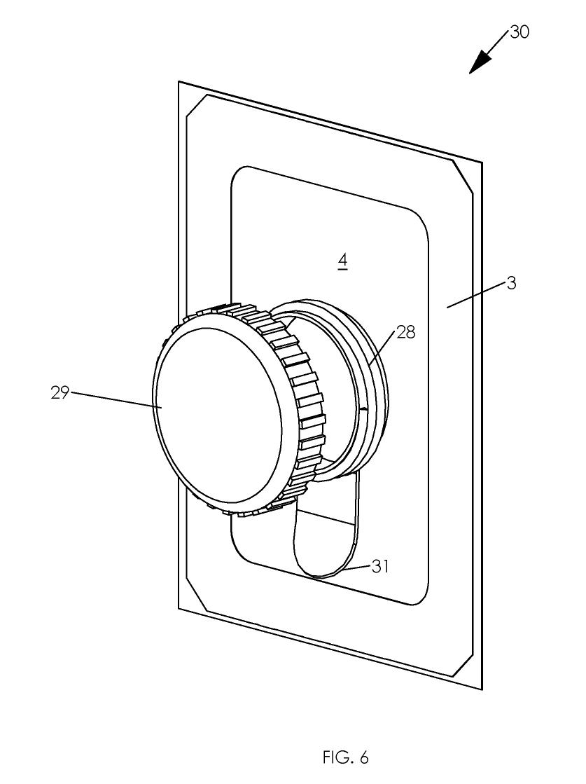

The alternative embodiment, illustrated in FIGS. 5a-5c, is a rough-in enclosure 25 which can be installed with an electrical box during the rough-in stage of new construction. Front flange 26 is taped to a polyethylene membrane. As shown, conical forms 12 may be designed to receive conduit, wire and armored cable of differing sizes. The inward direction of the conical forms 12 facilitates installation of the penetrating entity. An aperture 27 is located in the bottom wall of enclosure 25. Foam 15 is bonded to the enclosure to encompass aperture 27 and serve as an access site for piercing the enclosure without compromising the vapor barrier. Other means of sealing the penetrating entity described in other embodiments are applicable to this embodiment.

An alternative vapor barrier assembly that permits manual access to a wall interior is shown in FIG. 6. Assembly 30 is a generally planar entity rather an enclosure as shown in the previous embodiments. Threaded port 28 integral to planar surface 4 permits access, with a finger, hand or tool, to the far side of the assembly 30 in order to apply pressure and bond to the far side of the membrane being repaired. Release liner 3 protects the adhesive until the assembly is in place and can then be removed to permit bonding. After bonding, the threaded cap 29 is threaded onto the threaded port 28 to ensure that a hermetic seal is created. Tab 31, bonded to the threaded port 28, is held when cap 29 is being tightened in order to provide an equal and opposite force without straining the bond. The threaded elements can be manufactured by injection molding and laminated or ultrasonically welded to the planar surface 4.

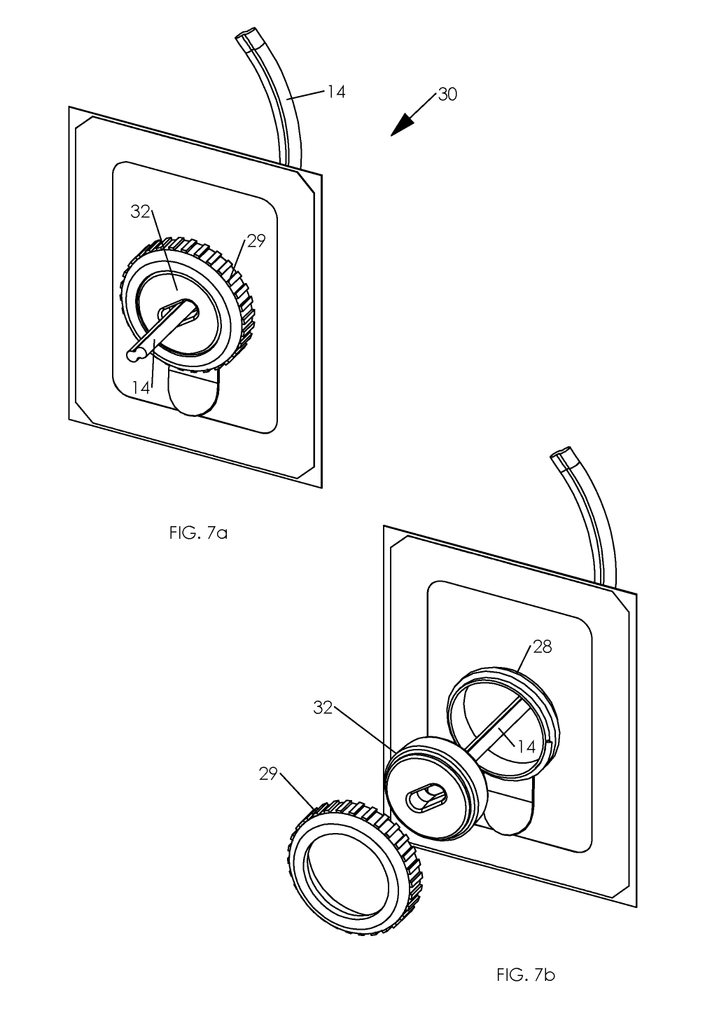

FIGS. 7a and 7b illustrate a modification of the assembly shown in FIG. 6, wherein access of a wire from the space behind wall 8 can be made while maintaining vapor seal functionality. A tapered elastomeric gland 32, when compressed between threaded port 28 and cap 29 will compress the wire 14 or other penetrating entity and maintain the hermetic seal across the membrane. This compressed gland means of sealing around the wire can also be applied to an enclosure similar to the one shown in FIG. 1.

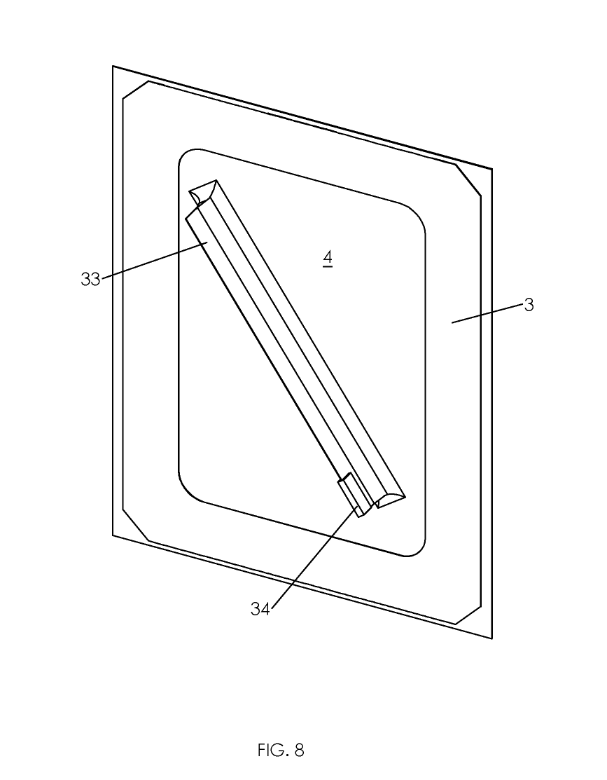

An alternative to the embodiment of FIG. 6 is shown in perspective in FIG. 8. A zipper lock type device 33 permits access to the far side of the planar surface 4. A finger, hand or tool may be inserted through the aperture in the zipper lock device 33 in order to apply force on the far side of the planar surface 4 to facilitate bonding after surface 4 is in place and adhesive release liner 3 is removed. The finger, hand or tool can then be removed and the zipper lock device 33 closed to complete the seal. Slider 34 facilitates opening and closing of the aperture in the zipper lock device 33. This assembly permits continued re-sealable access through the barrier. For example, assembly would facilitate access to a seasonally adjusted water valve located within the wall cavity behind the vapor barrier. The assembly can be manufactured by ultrasonically welding the zipper lock device to the planar surface 4, which can be prepared by die cutting. Similarly, the adhesive and release liner can be prepared for assembly by die cutting.

An alternative embodiment is illustrated in FIG. 9. Assembly 30 includes a tubular entity 37 that extends from planar surface 4. Access to the far side of surface 4 is achieved by inserting a finger, hand or tool through the tubular entity 37. The adhesive release liner 3 is removed after the assembly is in place to permit bonding. Once bonding is complete, the tubular entity is rolled up and secured in place with clasp 36 on strap 35. Entity 37 may be laminated or hermetically stitched to the planar surface 4, creating a hermetically sealed assembly. As a further modification, the clasp can be located on opposite sides at the outward extremities of the tubular entity and secured thereto after rolling to create the seal. Tape can be employed in lieu of a clasp.

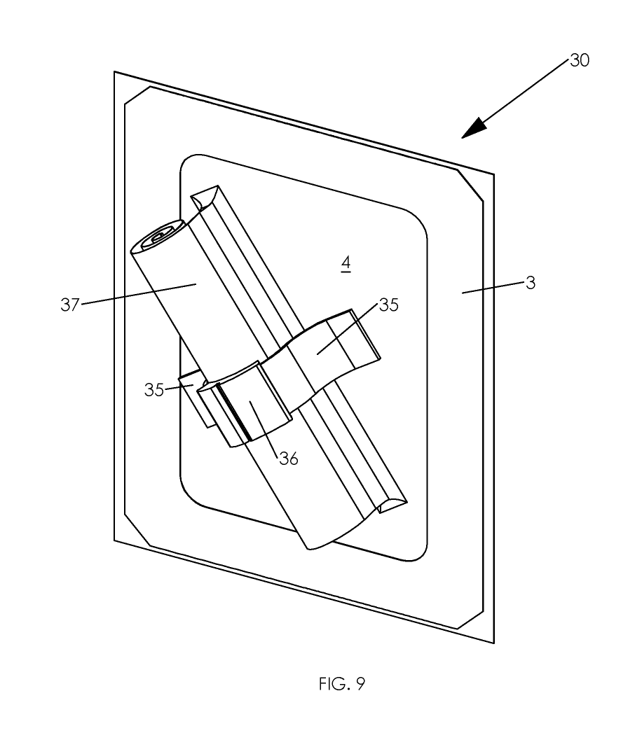

A further modification of the assembly of FIG. 9 is shown in FIG. 10. Assembly 30 comprises a short tubular entity 38 which extends from planar surface 4. The short tubular entity 38 permits access to the far side of the surface 4 for bonding to the membrane to be repaired. After bonding, tape 39 can be applied to an outward edge of the short tubular entity 38 to create the seal. The tape can be integral to the short tubular entity with a release liner that is removed in order to seal planar surface 4.

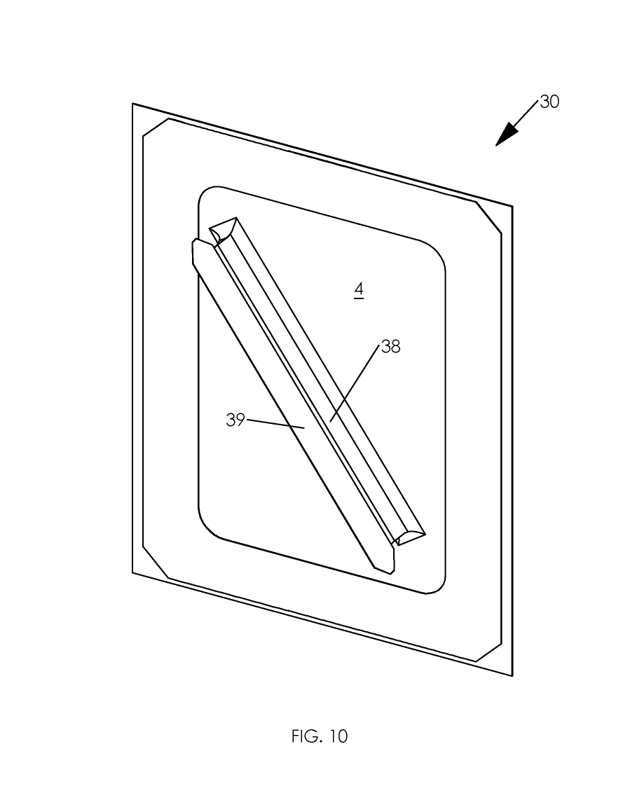

FIG. 11 is a perspective view of a vapor barrier assembly that is suitable for maintaining an air/vapor seal around a recessed ceiling light fixture. The recessed light fixture would have low heat generation, e.g. an LED, and would be of the rework type which does not require access to the space above the ceiling. This type of fixture typically is connected to a junction box with a transformer extending from the light engine. Similar to the installation shown in FIG. 5 and FIG. 6, after the enclosure is inserted through the opening in the ceiling and the existing vapor barrier above the ceiling, planar surface 4 is bonded to the vapor barrier via a bonding means such as shown in FIG. 1. The fixture can then be passed through the opening in the ceiling, the vapor barrier and aperture 5. The fixture can then be secured in the ceiling in any conventional manner, such as by screw tightening arms that sandwich the ceiling substrate against the fixture's flange on the lower surface of the drywall. The fixture will be housed within the enclosure 1 and the continuity of the existing vapor barrier will be maintained. The enclosure can be manufactured by blow molding and an adhesive applied to planar surface 4. This embodiment can be modified to accommodate recessed light fixtures of other configurations, as illustrated in FIG. 12. Enclosure 1, with planar surface 4 and aperture 5, is suitable for maintaining an air/vapor seal around a recessed light fixture or other ceiling or wall mounted object.

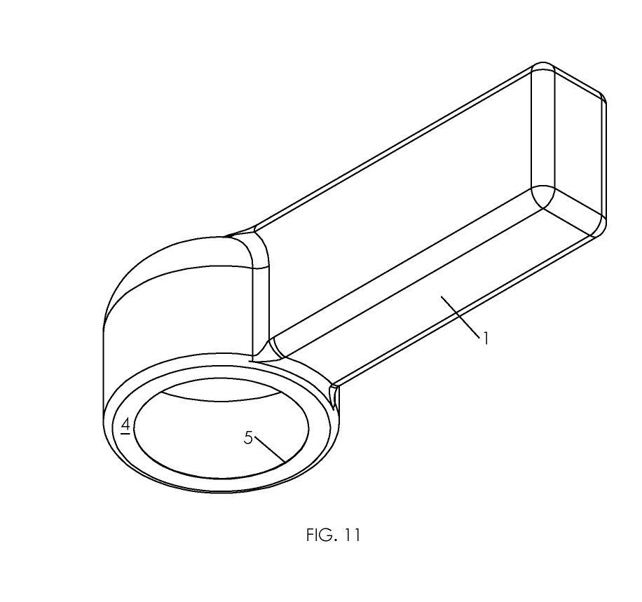

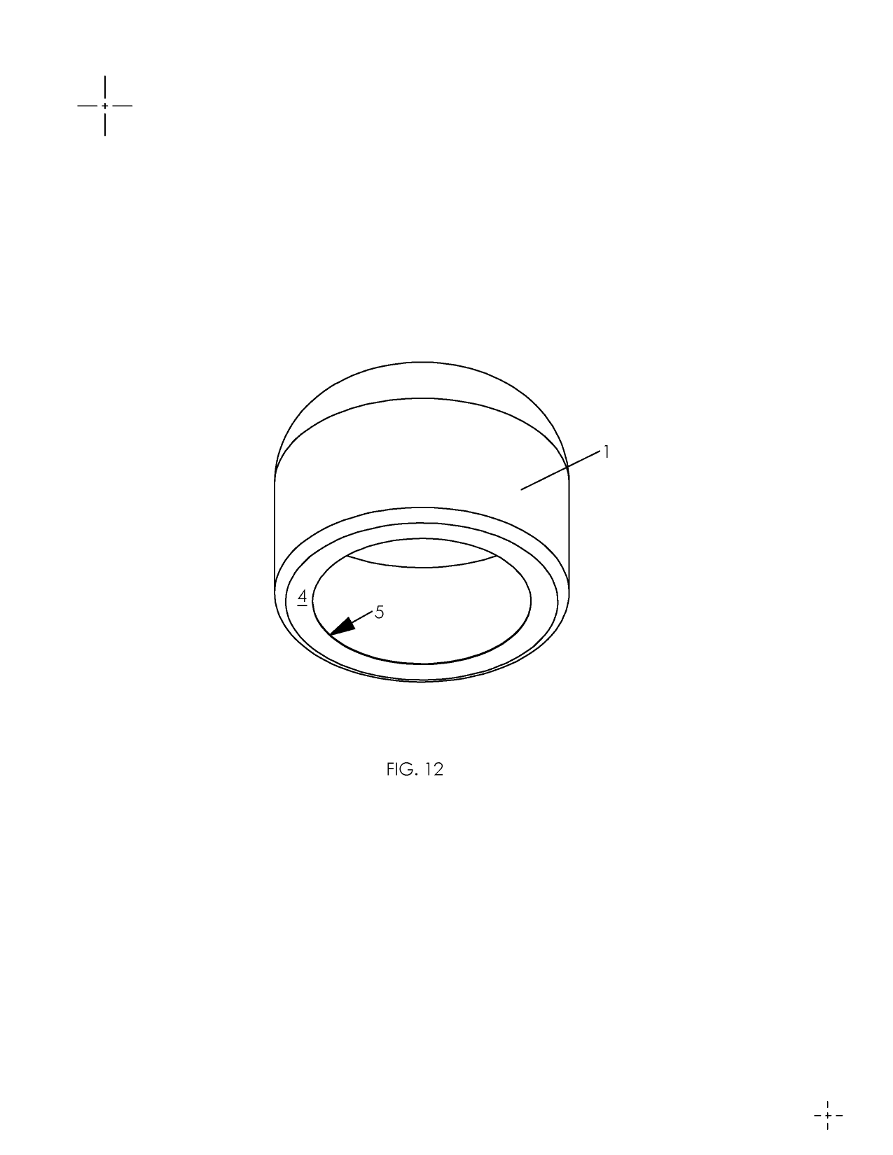

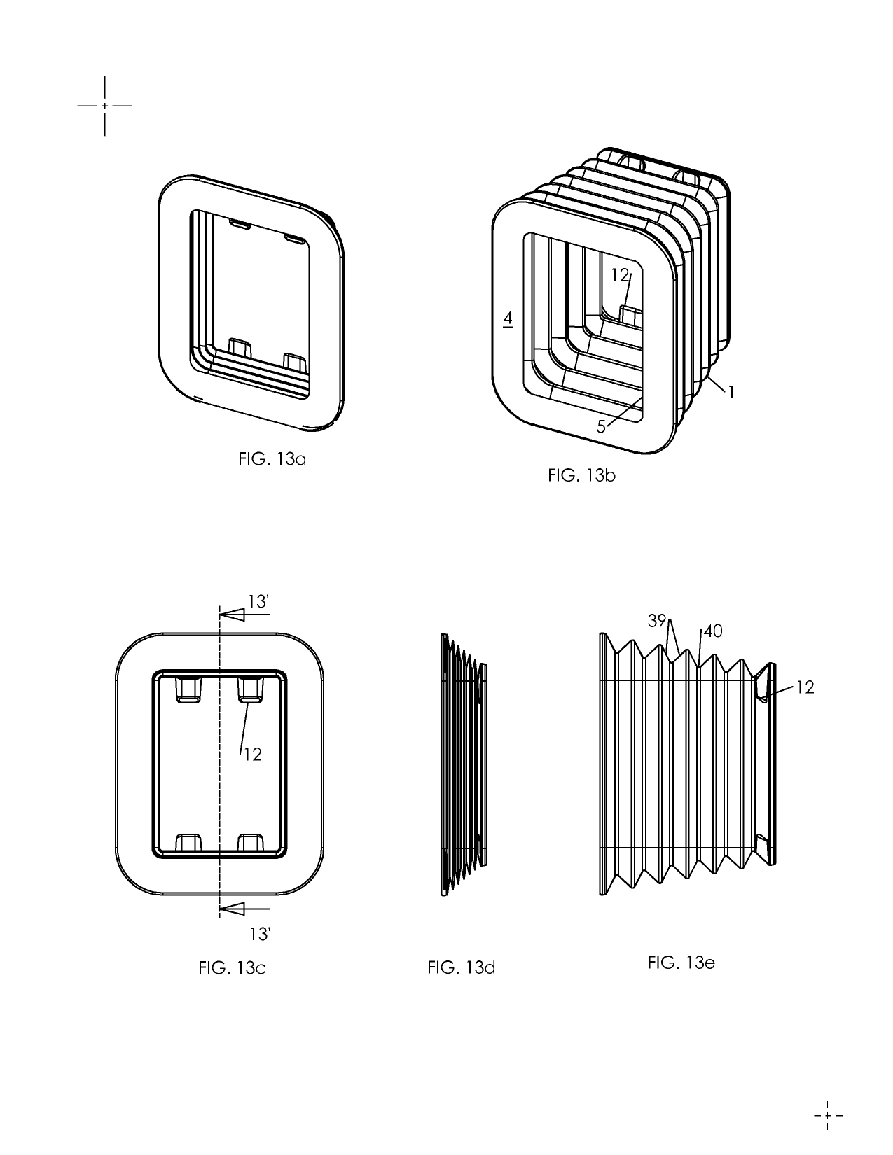

FIGS. 13a-13e illustrate an alternative embodiment of a vapor barrier assembly having an accordion or bellows like enclosure. Such configuration facilitates collapsibility for reduced volume for shipment and storage, as well as for easing passage through the hole in the opening in the wall. FIG. 13a is a perspective view of the enclosure in its collapsed state. FIG. 13b is a perspective view of the enclosure in its expanded state. Adhesive and release liner are applied to planar surface 4 in order to fix the enclosure to the membrane, as described in with respect to FIG. 1a. Aperture 5 permits access to the enclosure 1. FIG. 13c is a front view for both states. Conical forms 12 extend inside the enclosure. FIG. 13d is a section view 13′ of FIG. 13c in the collapsed state. FIG. 13e is a section view 13′ from FIG. 13c in the expanded state. The ends of conical forms 12 can be snipped when needed during installation with scissors to permit passage and sealing of respective wires. Flat accordion-like surfaces 39 when collapsed lay substantially flat against each other. Bend lines 40 facilitate the collapse and expansion. The enclosure is tapered to ensure that bends do not align with each other when collapsed in order to provide maximum compression.

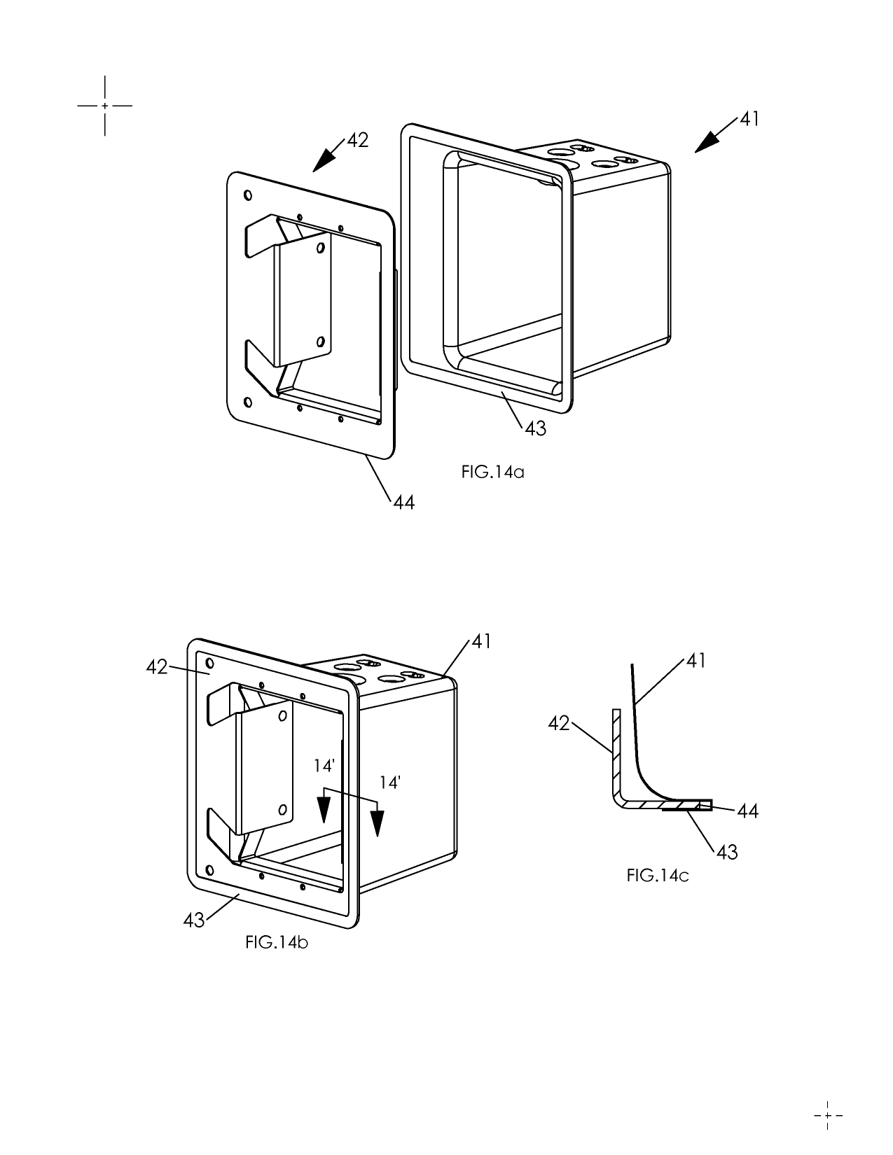

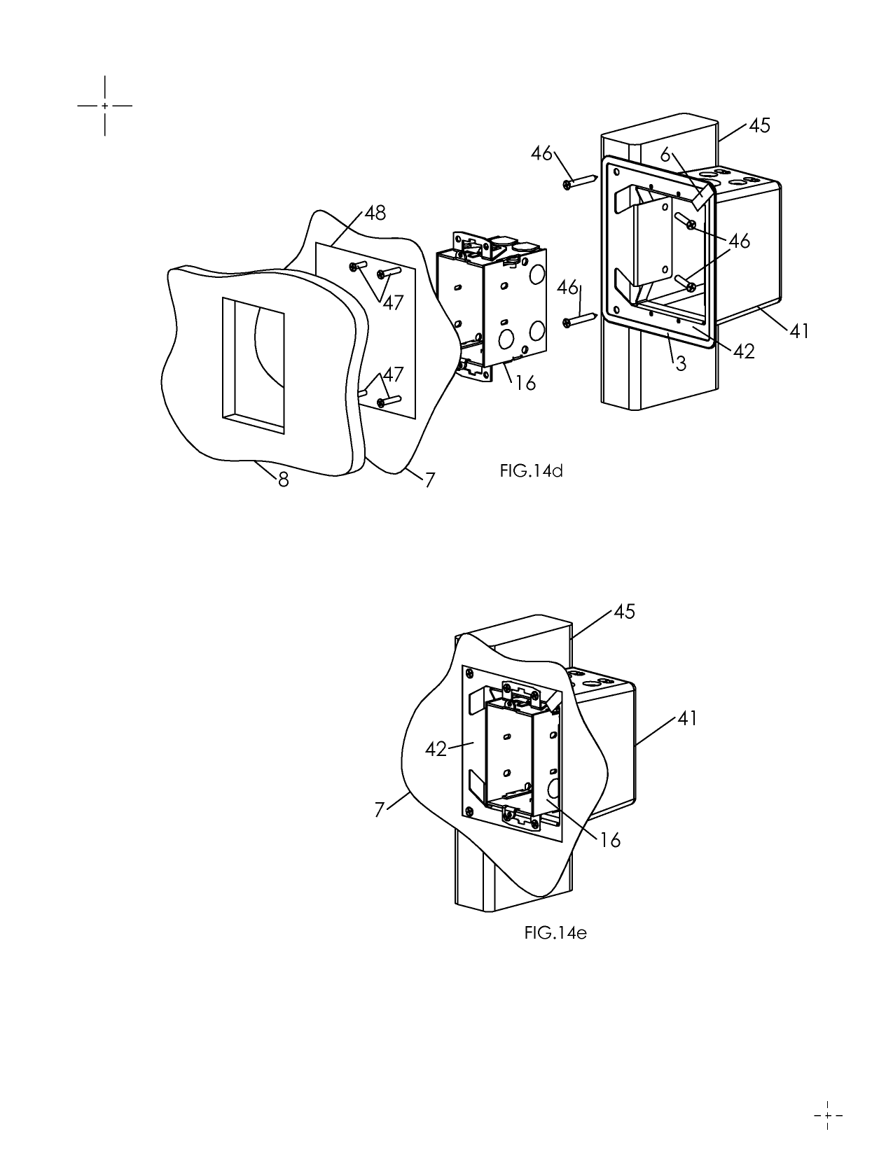

FIGS. 14a-d illustrate a vapor barrier assembly for new construction. FIG. 14a is an exploded view of vapor barrier enclosure 41 and sheet metal bracket 42. Enclosure 41 may be fabricated by injection molding with a resilient material, such as thermoplastic polyurethane. Enclosure 41 includes wire access sites such as described earlier in more detail with respect to FIGS. 5a and 5b. FIG. 14b is a perspective view enclosure 41 mounted on bracket 42. To install enclosure 41 on bracket 42, flexible flange 43 of the front surface of the enclosure is stretched over the bracket front face outside edge 44, as illustrated more clearly in the partial section view of FIG. 14c. Adhesive and release liner are applied to the surface 43 at its outer face. Pull tab 6, shown in FIG. 14d, allows the release liner 3 to be withdrawn after the enclosure is in place.

FIG.14d is an exploded view of the assembly mounted to a stud 45, with electrical box 16 contained in the enclosure cavity and installed behind wall 8. FIG. 14e is a perspective view the mounted assembly. Fasteners 46 inserted through holes in bracket 42 hold the bracket and enclosure 41 to the stud 45. Electrical box 16 is mounted to the bracket with fasteners 47. Thereafter, vapor barrier membrane 7 is applied over enclosure 41 and an aperture 48 is cut to allow access to the box 16. An installer can reach through the aperture, and grasp the release liner pull tab 6 to expose the adhesive and bond the enclosure 41 to the membrane 7 by applying pressure to the outside of the membrane in the area of the adhesive. In lieu of the adhesive and release liner, the membrane aperture can be sized such that the membrane can partially overlap the front surface 43 of the enclosure where tape can be used to make the seal. The drywall 8 can be installed the conventional manner.

FIG. 15 is a perspective view of a vapor barrier enclosure to be installed on a bracket in a manner similar to that described with respect to FIGS. 14a-c. The enclosure 41 is expandable and collapsible in the same manner as earlier described in more detail with respect to FIGS. 13a and 13b. Wall 39, in its collapsed state, reduces product volume during shipping, storage, merchandising, and later stages prior to installation. The expandability allows for installation on studs of differing depths and accommodates boxes of varying depths. The flexible flange 43 of the assembly is stretched over the bracket front face outside edge as shown in FIG. 14c. The accordion surfaces 39, when collapsed, lay substantially flat against each other. Conical form 12 is designed to accept and seal around a wire as shown and described with respect to FIGS. 4b-4j. FIG. 16 is a perspective view of a vapor barrier enclosure to be installed in a manner similar to that described with respect to FIGS. 5a-c. Planar surface 26 is taped to the vapor barrier membrane and fixed to a stud with an electrical box. Enclosure 39 is expandable and collapsible in the same manner as the embodiment shown in FIG. 15 to provide the same described advantages.

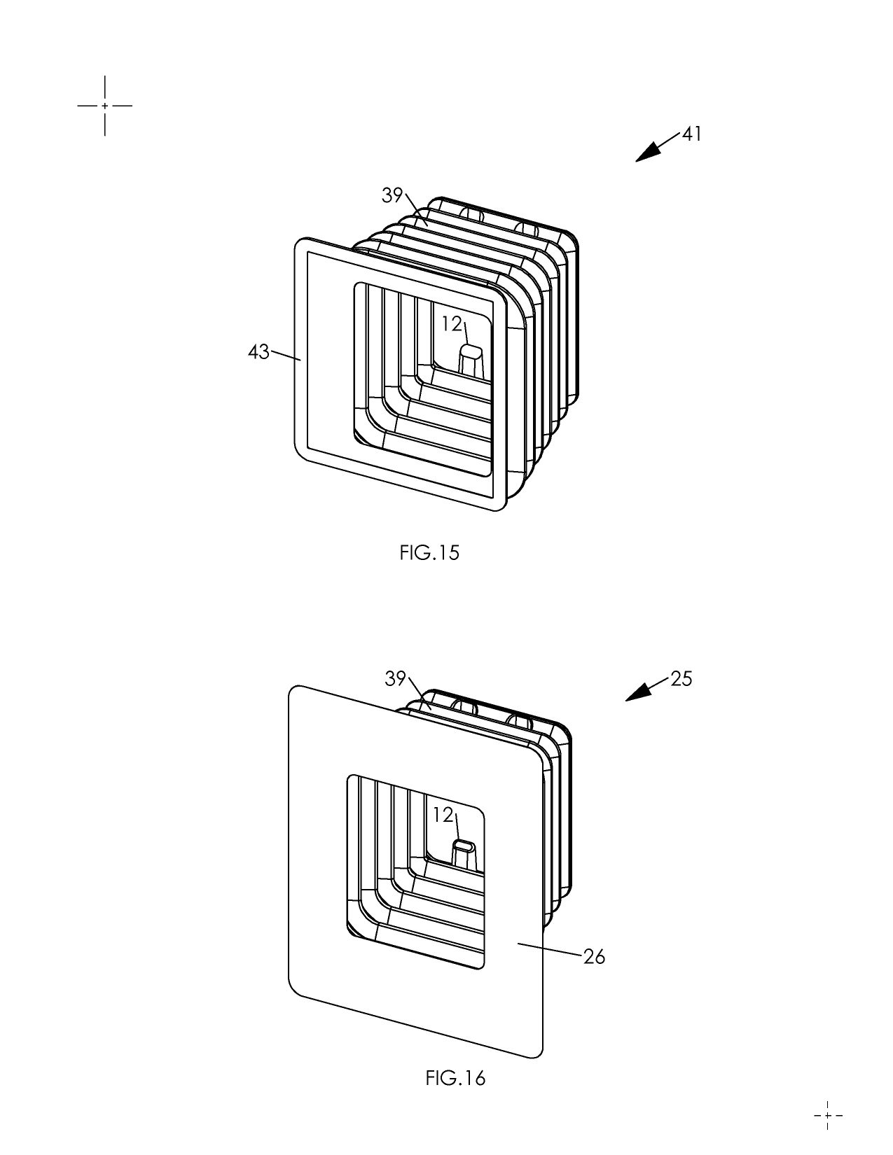

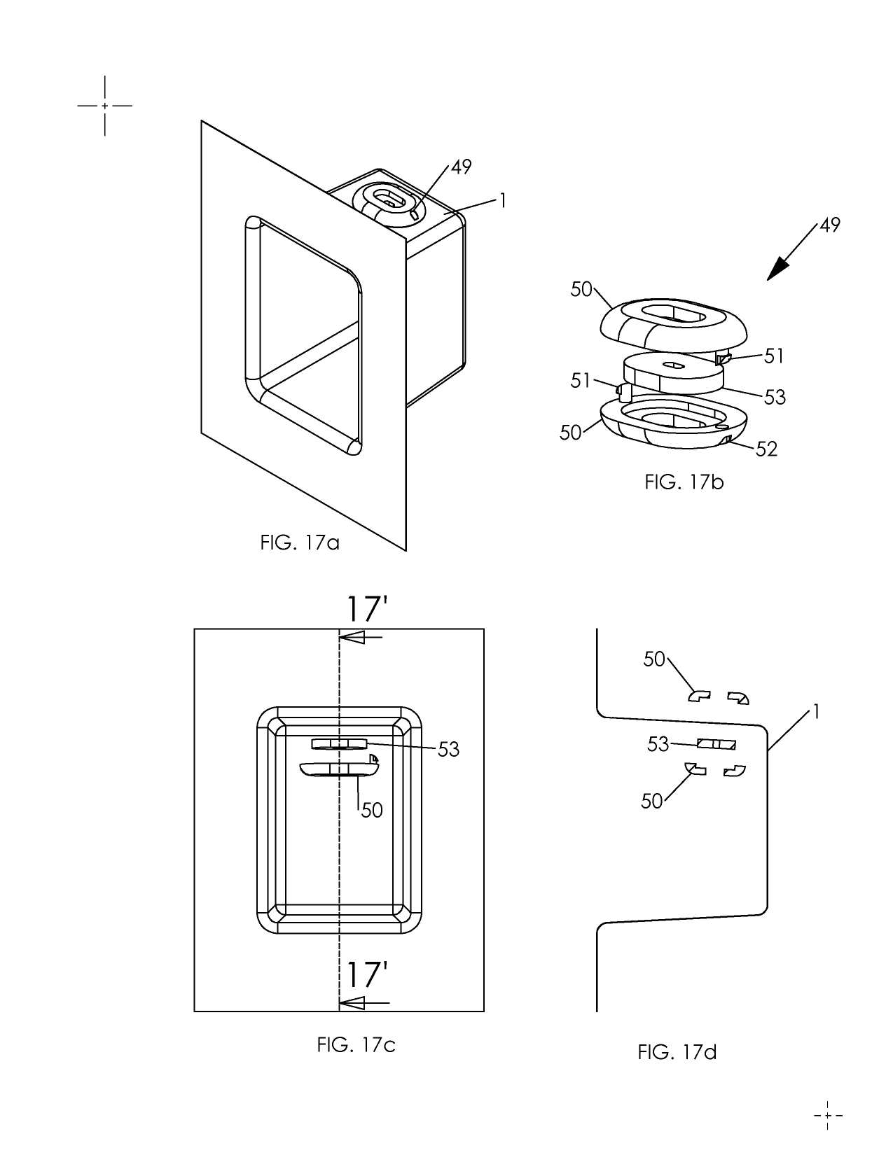

FIGS. 17a-d illustrate another vapor barrier assembly that can be used for new construction. The perspective view of FIG. 17a illustrates an enclosure 1 having a grommet assembly 49 formed thereon to provide sealed access to an electrical conduit, wire or other penetrating entity. An exploded view of the grommet assembly 49 is shown in FIG. 17b. Two identical plastic parts 50 each comprise a barb 51 and female receptacle 52. This configuration permits snapping both parts 50 together with barbs 51 engaging the female receptacles 52 of oppositely facing parts 50 with washer 53 therebetween. Washer 53 may comprise elastomeric material.

FIG. 17c is a front view of the vapor barrier assembly with the grommet assembly shown exploded. FIG. 17d is a partial section view taken at section 17′-17′ of FIG. 17c. When barbs 51 penetrate the enclosure wall 1 and engage the female receptacles 52 on the other side, the enclosure wall 1 and the washer 53 are sandwiched. The washer 53 inside diameter is smaller than the wire or penetrating entity. After the grommet assembly 49 is installed on the enclosure 1, a screwdriver or relatively sharp tool can be inserted through the inside diameter of the washer to puncture the enclosure wall 1. The penetrating entity can then be inserted. Radial pressure from the resilient washer 53 against the penetrating entity seals the enclosure. Alternatively, the penetrating entity can be inserted through the washer 53 and a punctured hole in the enclosure wall 1 prior to grommet assembly. The grommet assembly 49 can then be assembled by compressing the enclosure wall 1 and the washer 53. The inside diameter of the washer 53 will be decreased to prevent the entity from moving in relation to the enclosure wall. A vapor seal is thereby maintained.

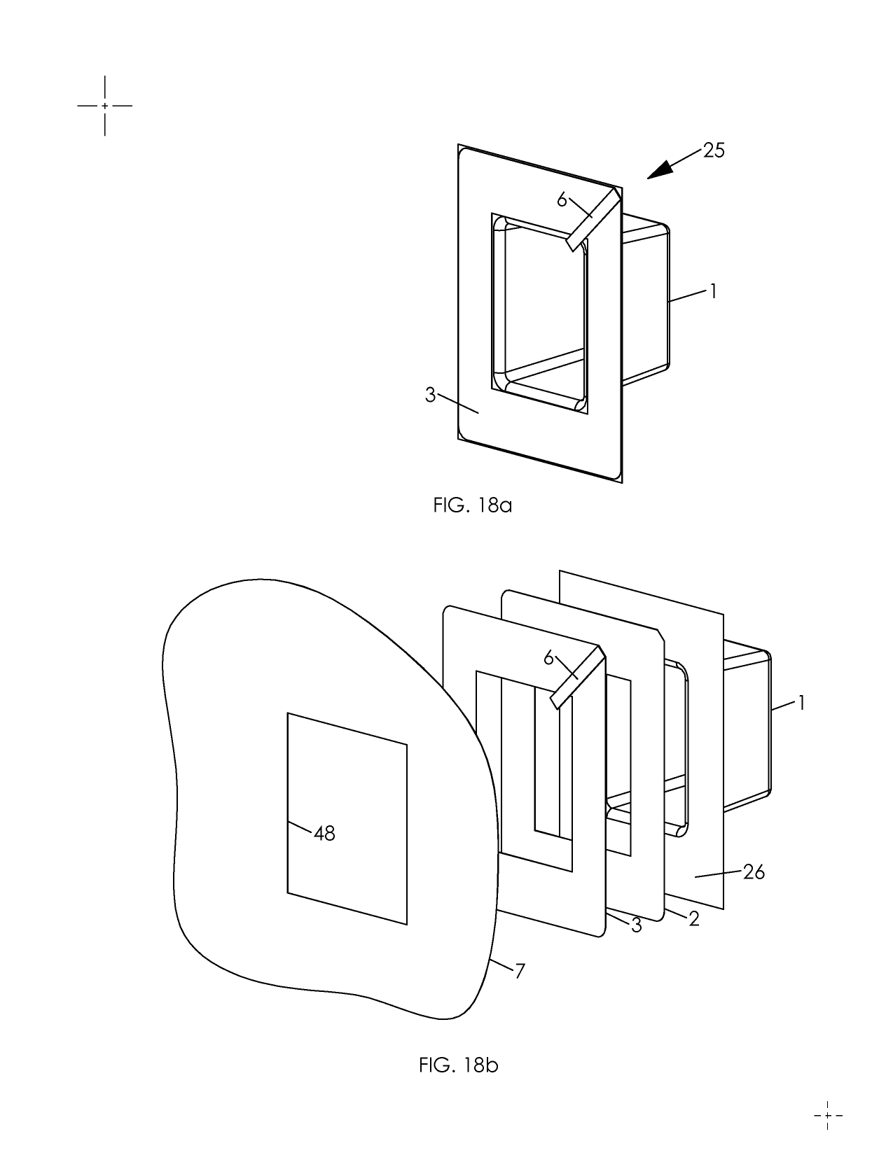

FIGS. 18a and 18b are perspective and exploded views, respectively, of a vapor barrier assembly for new construction. The assembly has attributes similar to those of FIGS. 5a and 14d, discussed earlier in more detail. Adhesive 2 is applied to the front face 26 of the enclosure 1 and covered by a protective release liner 3 with pull tab 6. Vapor membrane 7 is applied over the surface of the enclosure and an aperture 48 is cut to allow access to the electrical box(not shown). An installer can then reach through the aperture, grasp the release liner pull tab 6 to expose the adhesive 2 apply pressure to the outside of the membrane in the area of the adhesive 2. The enclosure will then be sealed to the vapor barrier membrane.

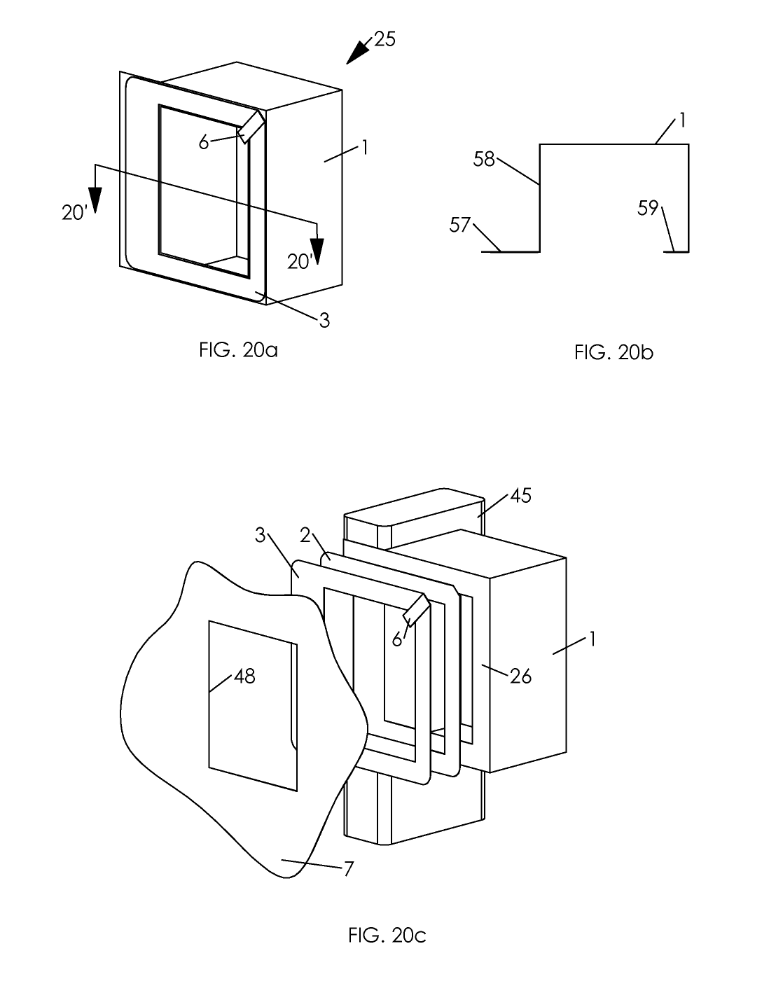

FIG. 20a is a perspective view of an alternative vapor barrier assembly to be used for new construction;

FIG. 20b is a partial section view of the assembly shown in FIG. 20a; and

FIG. 20c is is an exploded view of the vapor barrier assembly of FIGS. 20a and 20b for installation.

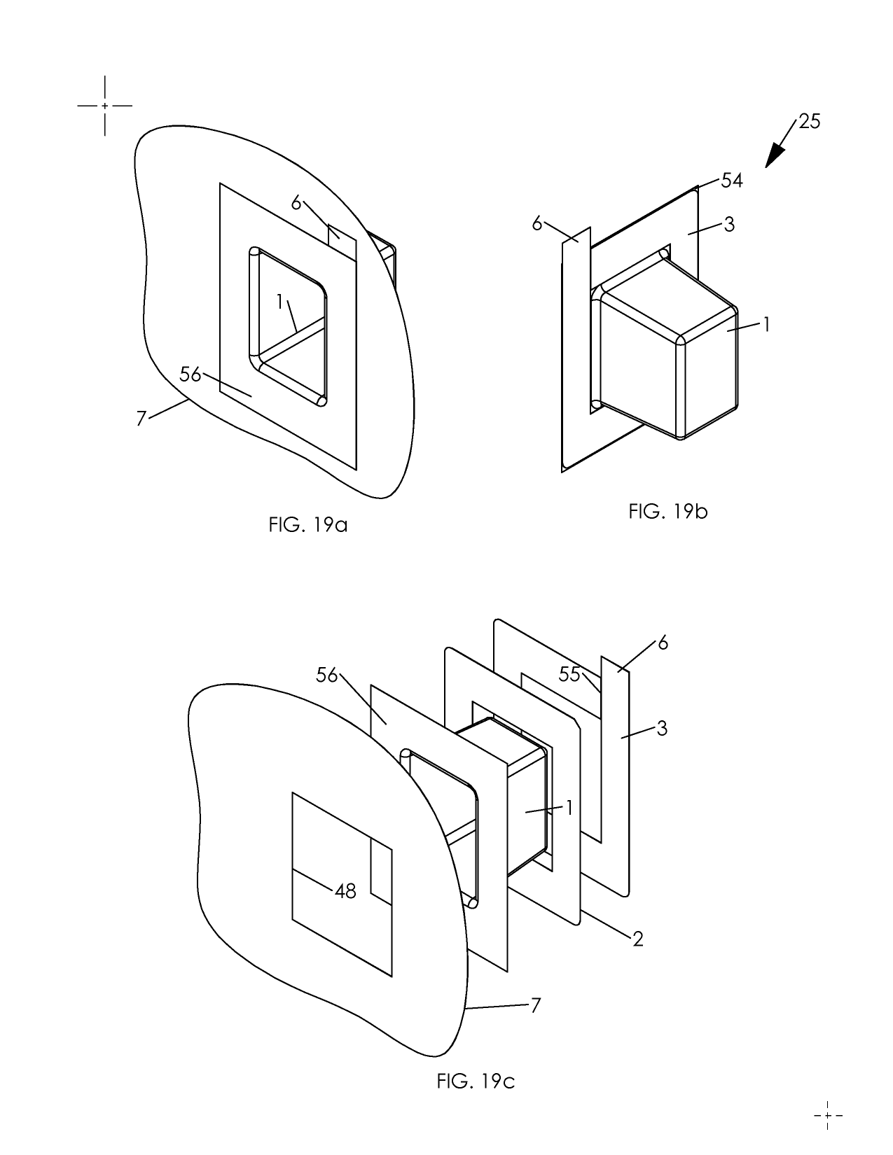

FIGS. 19a, 19b, and 19c are perspective and exploded views of a vapor barrier assembly for new construction. This assembly is a modification of the assembly of FIGS. 18a and 18b. Adhesive 2 is applied to the back face 54 of the enclosure 1 front flange 56 (FIGS. 19a, 19b) and covered by protective release liner 3 with pull tab 6. Vapor barrier membrane 7 is applied over the flange 56 and an aperture 48 is cut to allow access to the electrical box. An installer can then reach through the hole, grasp and pull flange 56, with adhesive 2 and release liner 3, through aperture 48 so as to overlap membrane 7. Pull tab 6 can then be grasped to remove the release liner. Pressure can then be applied to flange 56 to bond adhesive 2 to the membrane and create a seal. Slit 55 in the release liner 3 permits removal around the perimeter of the flange 56.

FIGS. 20a-c exemplify yet another alternative embodiment of the vapour barrier assembly 25 for new construction. Section 20′-20′ is shown in FIG. 22b. The illustrated configuration allows positively supported back pressure for effective bonding of the front surface 26 of the enclosure to the membrane 7. As in the previously disclosed embodiments, the enclosure can be made of polyethylene or the like and can be formed by injection molding, blow molding or other plastic forming method. Flanges can be affixed using additive means, such as plastic welding. Adhesive 2 is applied to the front surface of the assembly 26 and covered with release liner 3. Surface 57 and surface 58 lie respectively flush on front and adjacent side of stud 45. An electrical box (not shown) can be inserted in enclosure 1 and can be fixed to the stud 45 in conventional manner while holding the enclosure 25 in position. Membrane 7 is applied over the front of enclosure 25 and aperture 48 is cut in the membrane 7 to provide access to the electrical box, or other device to be installed. Access is provided to pull tab 6 that allows the release liner to be removed to reveal adhesive 2. Where the enclosure flange 26 overlaps the front of stud 45, pressure can be applied directly to the membrane to seal it against the flange 26. On the portion of the surface of flange 26 that is not supported by the stud, a compressive force can be applied to the front of membrane 7, and thus the adhesive 2 and surface 59 on the inside of the enclosure 1. Access to surface 59 allows fingers, or a tool to be inserted to be able to apply counter pressure and ensure that a positive bond is created.

In this disclosure there are shown and described only exemplary embodiments of the invention and but a few examples of its versatility. It is to be understood that the invention is capable of use in various other combinations and environments and is capable of changes or modifications within the scope of the inventive concept as expressed herein. For example, the term “building wall” is also applicable to building ceiling, as the concepts directed to vapor barrier protection for wall openings are applicable to ceiling openings.

What is claimed is:

1. A device for an opening in a vapor barrier membrane interior to a wall of a building structure, the device comprising:
an enclosure configured for insertion through a corresponding opening in the building wall; wherein the enclosure comprises:
a planar member having an aperture sized to surround the membrane opening, and an integrally walled cavity of flexible material extending from the planar member; and
a fastener joined to a surface of the planar member for bonding with an interior surface of the membrane, thereby forming a seal around the membrane within the cavity.

2. A device as recited in claim 1, wherein the fastener comprises:
an adhesive contained at the surface of the planar member;
wherein a compressive force manually applied between the planar member and the wall bonds the enclosure to the interior membrane surface.

3. A device as recited in claim 2, wherein the fastener further comprises a removable release liner covering the adhesive.

4. A device as recited in claim 2, wherein the adhesive comprises double sided adhesive tape fixed to the planar surface of the enclosure.

5. A device as recited in claim 2, wherein the adhesive is contained in a sealed blister pack cavity.

6. A device as recited in claim 1, wherein the enclosure cavity is configured to house an electrical device.

7. A device as recited in claim 6, wherein the enclosure comprises at least one access site for introducing a penetrating entity from outside the enclosure to the electrical device within the cavity.

8. A device as recited in claim 7, wherein the enclosure material is configured with a nominal thickness and the thickness of the enclosure material at the access site is less than the nominal thickness for penetration of the enclosure material by the electrical wire.

9. A device as recited in claim 7, wherein the access site comprises self sealing material.

10. A device as recited in claim 7, wherein the access site comprises a conical formation extending outwardly of the cavity wall.

11. A device as recited in claim 10, wherein the conical formation comprises a plurality of spaced marks corresponding respectively to different sized penetrating entities.

12. A device as recited in claim 7, wherein the access site comprises a formation extending into the cavity.

13. A device as recited in claim 7, wherein the enclosure comprises a plurality of substantially conically shaped access site formations extending into the cavity.

14. A device as recited in claim 13, wherein the plurality of access site formations are dimensioned to correspond, respectively, to different sized penetrating entities.

15. A device as recited in claim 6, wherein the electrical device comprises an electrical box.

16. A device as recited in claim 6, wherein the electrical device comprises a telecommunication connector.

17. A device as recited in claim 1, wherein the enclosure cavity is configured to house a plurality of electrical devices.

18. A device as recited in claim 1, wherein the enclosure comprises a collapsible side wall and a rear wall;
wherein a compressed state of the side wall permits a reduced volume of the cavity prior to insertion of the enclosure through the wall opening and an expanded state of the side wall permits maximum cavity volume after insertion of the enclosure through the wall opening.

19. A device as recited in claim 18, wherein the side wall comprises at least one access site for introducing an electrical wire from outside the cavity to an electrical device within the cavity.

20. A device as recited in claim 18, wherein the side wall is bellows-shaped.

21. A device for an opening in a vapor barrier membrane interior to a wall of a building structure, the device comprising:
a planar member of flexible material sized to surround the membrane opening, the flexible material comprising a sealable access site for providing access to the interior of the building wall; and
a fastener joined to a planar surface of the planar member for bonding with an interior surface of the membrane, thereby forming a seal around the membrane opening.

22. A device as recited in claim 21, wherein the access site comprises a threaded port for transitioning an electrical wire from the interior of the building wall to the exterior of the wall.

23. A device as recited in claim 22, further comprising:
a cap threaded for mating with the threaded port; and
an elastomeric gland compressed between the cap and the port;
wherein a hermetic seal is maintained by the device upon insertion of a penetrating entity through the gland.

24. A device as recited in claim 21, wherein the access site comprises a re-sealable plastic zipper.

25. A device for an opening in a vapor barrier membrane interior to a wall of a building structure, the device comprising:
an enclosure configured to seal an opening in the vapor barrier membrane; wherein the enclosure comprises:
a planar member having an aperture sized to surround the membrane opening, and an integrally walled cavity extending from the planar member; and
a fastener joined to a surface of the planar member for bonding with an interior surface of the membrane, thereby forming a seal around the membrane.

26. A device as recited in claim 25, wherein the fastener comprises:
an adhesive contained at the surface of the planar member; and
a removable release liner covering the adhesive.

27. A device as recited in claim 26, wherein the removable release liner comprises an accessible pull tab.

28. A device as recited in claim 25, wherein the enclosure cavity is configured to house at least one electrical device.

29. A device as recited in claim 25, wherein the enclosure comprises at least one access site for introducing a penetrating entity from outside the enclosure to the electrical device within the cavity.

30. A device as recited in claim 29, wherein the access site comprises self sealing material.

31. A device as recited in claim 30, wherein the access site comprises a formation extending into the cavity.

32. A device as recited in claim 30, wherein the enclosure comprises a plurality of substantially conically shaped access site formations extending into the cavity and dimensioned to correspond, respectively, to different sized penetrating entities.

33. A device as recited in claim 29, wherein the enclosure comprises a collapsible side wall and a rear wall;
wherein the side wall is configured to be expanded from a compressed state to obtain maximum cavity volume.

34. A device as recited in claim 25, wherein cavity wall comprises flexible material.

35. A device for an opening in a vapor barrier membrane interior to a wall of a building structure, the device comprising:
an enclosure configured to seal an opening in the vapor barrier membrane; wherein the enclosure comprises:
a planar member having an aperture in a planar surface thereof sized to surround the membrane opening, the planar member projecting from the planar surface to form a channel configured to engage a flange mounted to the building structure; and
an integrally walled cavity extending from the flexible member;
wherein a compression seal is established between the planar member and the vapor barrier membrane when wall construction is completed.

36. A device as recited in claim 35, wherein the enclosure comprises at least one access site for introducing an electrical wire from outside the enclosure to the electrical device within the cavity.

37. A device as recited in claim 36, wherein the access site comprises an airtight grommet assembly.

38. A device as recited in claim 35, wherein the member and the cavity wall comprise flexible material.

39. A device as recited in claim 35, further comprising a fastener joined to a surface of the planar member for bonding with an interior surface of the membrane, the fastener comprising a removable release liner covering an adhesive.
